(19) United States
(12) Patent Application Publication
(10) Pub. No.: US 2017/0353745 A1
(43) Pub. Date: Dec. 7, 2017

(54) SECURE MEDIA PLAYER

(71) Applicant: Gurulogic Microsystems Oy, Turku (FI)

(72) Inventors: Tuomas KÄRKKÄINEN, Turku (FI); Ossi KALEVO, Akaa (FI)

(21) Appl. No.: 15/532,336

(22) PCT Filed: Dec. 8, 2015
(86) PCT No.: PCT/EP2015/025097

§ 371 Date: Jun. 1, 2017

(30) Foreign Application Priority Data
Dec. 8, 2014 (GB) 142181.6

(51) Int. Cl. H04N 21/2347; G06F 21/10; H04N 21/266; H04N 21/4627

(52) U.S. Cl. CPC H04N 21/23476; H04N 21/4627; G06F 21/10; H04N 21/26613

(57) ABSTRACT

A secure media player system for communicating media content information from an encoder to a decoder is provided. The encoder is operable to:
process and encode media content information into section(s) of encoded data. The section(s) of encoded data include parameters which enable the media content information to be regenerated from the section(s) of encoded data;
encrypt the section(s) of encoded data to generate corresponding encrypted section(s) of encoded data; and
communicate the unencrypted and/or encrypted section(s) of encoded data to the decoder for the decoder to process the unencrypted and/or encrypted section(s) of encoded data to render the media content information to one or more users, wherein the secure media player system does not store or allow storage, namely prevents storage. of the section(s) of encoded data in a decrypted form to unprotected memory.

### TECHNICAL FIELD

The present disclosure relates to secure media players, to methods of operating the secure media players, to systems including the secure media players and also to methods of operating the systems. Moreover, the present disclosure is concerned with computer program products comprising a non-transitory computer-readable storage medium having computer-readable instructions stored thereon, the computer-readable instructions being executable by a computerized device comprising processing hardware to execute aforesaid methods.

### BACKGROUND

Various different content producers operate in connection with the contemporary Internet, such as cinema production companies in Hollywood (USA), independent professional content producers, advertisement content producers and so forth. Moreover, private citizens produce all sorts of media content via use of YouTube (“YouTube” is a registered trade mark®) and other social media sites and applications. Furthermore, several service providers operate in the Internet to offer their clients movies and TV series, or even live content via use of direct streaming of data content. Additionally, globally, there are various different security implementations in use which attempt to implement protection, for example for national security or commercial purposes, for example for governments, corporations, associations and other organizations, and also for consumers. With amounts of data content being communicated increasing into the future, a task of monitoring data content against criminal activities is becoming increasingly burdensome for security organisation such as the NSA (USA), GCHQ (UK), CIA (USA), FBI (USA) and similar, especially when the data content is heavily encrypted.

If a given consumer uses a given media content product without paying, it is usually a producer of the given media content who suffers commercial losses. Media companies have sued private citizens and groups of citizens and organizations for distributing illegal copies of media content that was copyright-protected. A recent example of such a legal trial relates to “The Pirate Bay” trial, wherein individuals who maintained an Internet website and associated service were sentenced to prison and to pay fines to copyright organizations and to media corporations.

In known technology, encryption techniques have often been implemented in such a way that media content information has been produced in an unencrypted format, and the media content information is encrypted just prior to transmitting it, either by using an encrypted connection or by encrypting the media content information itself. The former approach of encryption just prior to transmission often encounters a problem that even though a given used transfer channel were secure, for example HTTPS or SSH, a given recipient still stores the media content information itself in unencrypted format at his or her media content device, for example as a “download”, thus making it possible to leak the media content information into wrong hands from the media content device; such leaking can occur through malware that accesses decoded media content that is stored in RAM or non-volatile data memory of the media content device. However, such an encrypted transfer connection does enable a real-time online service to be offered to users, because the encryption is executed on the connection, and not on the media content information itself.

Various ways for encrypting information have been developed along with the development of reading and writing, and encryption techniques have been used since the times of Classical Antiquity, especially for military purposes. However, it is especially because computers and information networks became more and more common during the twentieth century that a multitude of approaches for encrypting information have been developed. The most widely known of these is the RSA (see reference [1]), which was the first encryption technique that used public keys. It was considered very strong and it gave an impression of being unbreakable.

Later on, as information technology has become more commonplace even among normal businesses and private citizens, on the basis of RSA, PGP (Pretty Good Privacy, see reference [2]) has been developed which is very well suited for encrypting both e-mails and hard drives of computing devices which are capable of storing media content information. A person of ordinary technical skill knows that a process of encrypting information operates in such a way that either a given entire information sequence, or a part of the information sequence, is encrypted so that only authorized parties are able to read it. Such encryption converts plain text information into encrypted information by using an encryption key, so that the encrypted information can be read, namely “opened”, only if the encrypted information is decrypted with a right key which a given encrypting party has given to a recipient of the encrypted information. It is also well-known that it is in theory possible to break encrypted information, without having access to an encryption key used to generate the encrypted information, but such decryption without use of an encryption key would require so much computing capacity that it has not so far been possible to implement in practice, other than with by using gigantic computing resources that only certain intelligence agencies possess.

However, nowadays, on account of increased data processing capacity being provided by advanced data processing devices such as reduced instruction set computers (RISC), it is also possible to encrypt entire media content information, which enables offering an offline service, namely the media content information is encrypted specifically for certain recipients. Such an approach does not however make it possible to provide as cost-effective a solution pursuant to the present disclosure, because known approaches involve using considerable computer processing power at recipient devices; such power dissipation is especially pertinent when the recipient devices are portable battery-powered devices, for example smart phones, portable video players, portable audio devices and such like. Moreover, such considerable computer processing time is to be taken into account, especially in server arrangements where, for example, movies are transmitted in real time, because embodiments pursuant to the present disclosure make it possible to serve several client terminals simultaneously, yet using only a fraction of computing resources compared to known approaches where a whole given movie is encrypted, for each recipient, separately.

In a United States patent document US 2004/0236940 A1 (Pioneer Corp.; “Contents Supplying System Method and Program”), there is described a manner in which contents to be supplied to a given user are divided into a core portion and one or more non-core portions, wherein an encryption process is applied to the core portion which is supplied to the given user. Since a significant portion of the contents is used as the core portion, which is encrypted and transmitted, a whole of the contents can be substantially protected by the encryption of only the core portion.

In another United States patent document US 2004/0236956 A1 (Shen et. al.; “Apparatus and Method of Flexible and Common IPMP System for Providing and Protecting Content”), there is described an apparatus for a flexible and common IPMP (Intellectual Property Management and Protection) system, offering flexibility and interoperability by incorporating a complete IPMP tool list stored in a content stream or downloaded from a URL location. The IPMP tool list is parsed, and an IPMP tool is acquired based on the IPMP tool ID, related location identifier, and IPMP tool format ID.

In yet another U.S. Pat. No. 8,804,956 B2 (Laurent Hiriart; “Method and Device for the Partial Encryption of a Digital Content”), there is described a method of enciphering the digital content intended to be deciphered and retrieved on mobile terminals. This makes it possible to limit the computing power necessary for the deciphering and therefore the energy used. The content is partially enciphered. A signature of header data ensures the integrity of the data.

In still another United States patent document US 2008/0010653 A1 (Ollikainen et. al.; “Method and Apparatus for Controlling Access to and Usage of a Digital Media Object”), there is described a method for handling a data stream representative of a digital media object to be protected against unauthorized use. The unauthorized use can be prevented by extracting selected portions of data from a stream of an original digital media object and then mass distributing the remaining incomplete media object.

In yet another United States patent document US 2013/0315438 A1 (Robert et. al.; “Method for Guaranteeing Watermark Embedding by Using Bit Stream Corruption), there is described a method for preventing bypassing of watermark embedding in a bit-stream representative of audio/video data. The bit-stream is corrupted, wherein original blocks in the bit-stream are replaced by corrupted blocks producing a non-compliant bit-stream. The corrupted bit-stream is repaired by replacing each corrupted block, wherein at least one corrupted block is replaced by a watermarked block and at least one corrupted block is replaced by an original block, producing a compliant repaired and watermarked bit-stream.

In still another United States patent document US 2006/0005047 A1 (Lekatsas et al.; “Memory Encryption Architecture”), there is described a system architecture for supporting fast random access to encrypted memory. A buffer is deployed to hold frequently used decrypted frames that can be readily accessed by a processor. An encryption/decryption engine, coupled to the buffer, preferably takes advantage of a counter-mode block cipher algorithm to encrypt and decrypt pages of data.

Furthermore, in a published article titled “Partial Digital Video Scrambling and its Applications” (Wim Mooij), there is described a visible scrambling approach for encrypting compressed digital video content. An encrypted digital television signal completely obscures the content. When a receiving equipment cannot decrypt the signal the viewer will see a message advising the viewer how to obtain viewing permissions for the encrypted digital television content.

Thus, the present disclosure seeks to provide an at least partial solution which makes it possible to distribute and render media content information more safely as regards needs of content information owners. As aforementioned, it is one of the worst problems for media content information producers and media content information owners that they cannot be sure whether or not their produced media content information will at some point in time end up in wrong hands or end up in a public file sharing Internet site. Media content information produced for commercial purposes has always had production costs associated therewith, and it is always customers, usually consumers, who pay for these costs.

### SUMMARY

The present disclosure seeks to provide an improved secure media player which is operable to communicate and render media content information in a more secure and efficient manner.

Moreover, the present disclosure seeks to provide an improved method, in a secure media player, of communicating and rendering media content information in a more secure and efficient manner.

According to a first aspect, there is provided a secure media player system for communicating media content information (D1) from an encoder to at least one decoder, characterized in that the encoder is operable:
(a) to process and encode the media content information (D1) into one or more sections of encoded data (E2(A), E2(B), . . . ), wherein at least one of the one or more sections of encoded data (E2(B)) includes one or more parameters which enable the media content information (D1) to be regenerated from the one or more sections of encoded data (E2(A), E2(B), . . . );
(b) to encrypt at least one of the one or more sections of encoded data (E2(B)) to generate corresponding one or more encrypted sections of encoded data (encrypt(E2(B))); and
(c) to communicate at least one of the one or more unencrypted and/or encrypted sections of encoded data (encrypt(E2(B))) to the at least one decoder to process the one or more unencrypted and/or encrypted sections of encoded data (E2(A), encrypt(E2(B))) to render the media content information (D3) to one or more users, wherein the secure media player system:
   (i) prevents storage of the one or more encrypted sections of encoded data (encrypt(E2(B))) in a decrypted form, or
   (ii) stores the one or more encrypted sections of encoded data (encrypt(E2(B))) in a decrypted form to protected memory.

The present invention is of advantage in that the secure media player system prevents storage, namely does not store or allow storage, of the one or more encrypted sections of encoded data (encrypt(E2(B))) in a decrypted form to unprotected memory, namely any memory other than cache memory or other secure memory of an authorized recipient device.

Optionally, the secure media player system is implemented, such that at least one of the one or more sections of encoded data (E2(A), E2(B), . . . ) include customized content that is selectively included based on an identity of the at least one decoder and/or one or more characteristics of operation of the at least one decoder. Optionally, the customized content is included in a code-defining manner into the media content information (D3) when rendered at the at least one decoder, wherein the identity of the at least one decoder is discernible from the rendered media content information (D3).

Optionally, the secure media player system is implemented, such that the one or more encrypted sections of encoded data (encrypt(E2(B))) are encrypted using at least one encryption key that identifies the encoder when the at least one decoder processes the one or more unencrypted and/or encrypted sections of encoded data (E2(A), encrypt(E2(B))). Such an implementation enables the at least one decoder to check whether or not the media content information has been provided from a bona fide source, for example from a verified source, or is pirated media data content.

Optionally, the secure media player system is implemented, such that the at least one decoder is provided with a complementary key to that used by the encoder when generating the one or more encrypted sections of encoded data (encrypt(E2(B))), wherein the complementary key is used by the at least one decoder to process the one or more unencrypted and/or encrypted sections of encoded data (encrypt(E2(B))) to render the media content information (D3) to the one or more users.

Optionally, the secure media player system is implemented, such that the at least one key and/or the complementary key or a reference code of the complementary key are provided from at least one of: a validating authority, a certifying authority, a verification authority. More optionally, the at least one decoder is provided with a plurality of complementary keys from at least one of: a validating authority, a certifying authority, a verification authority. Yet more optionally, the encryption key or an order number or other ID of an encryption key or a key pair can be provided by Gurulogic® Encryption Key Wallet, as elucidated in further detail in patent application GB 1507154.1 filed by Gurulogic Microsystems Oy. An encryption key wallet is a data storage region which is only accessible by use of one or more keys, wherein the encryption key wallet includes various keys to be used for purposes of at least one of: verification, encryption, decryption, authorization.

Optionally, the secure media player system is implemented, such that the at least one encryption key and/or the complementary key are time-limited. Optionally, in this regard, the encoder is operable to define a period of time after which the one or more encrypted sections of encoded data (encrypt(E2(B))) are deemed expired, depending on whether the media content information (D1) is to be made available for online purposes or for offline purposes.

Moreover, optionally, the secure media player system is implemented, such that the encoder is operable to verify the authenticity of the at least one decoder, and the at least one decoder is operable to verify the authenticity of the encoder, thereby ensuring reliable communication of the media content information (D1).

Optionally, the secure media player system is implemented, such that the system is operable to customize uniquely the one or more encrypted sections of encoded data (encrypt(E2(B))) for each corresponding decoder.

Optionally, the secure media player system is implemented, such that at least the one or more unencrypted sections of encoded data (E2(A), E2(B), . . . ) are communicated via at least one relay and/or proxy server which is operable to service a plurality of decoders with the encoded data (E2(A)). In such a case, the at least one relay and/or proxy server is operable to supply and/or buffer the one or more unencrypted sections of encoded data (E2(A)), wherein the media content information (D3) is efficiently customized to each of the plurality of decoder.

According to a second aspect, there is provided an encoder for use with the secure media player system pursuant to the first aspect.

According to a third aspect, there is provided a decoder for use with the secure media player system pursuant to the first aspect.

Optionally, the decoder is operable to receive at least partially encrypted media content information (D3) and to process therefrom one or more unencrypted and/or encrypted sections of encoded data (E2(A), encrypt(E2(B)), . . . ) to render the media content information (D3) to one or more users, wherein the decoder:
(i) is prevented from storing the one or more encrypted sections of encoded data (encrypt(E2(B))) in a decrypted form, or
(ii) stores the one or more encrypted sections of encoded data (encrypt(E2(B))) in a decrypted form to protected memory of the decoder.
   Optionally, the decoder is operable to decrypt at least one of one or more sections of encoded data (E2(B) . . . ) to generate corresponding one or more decrypted sections of data (encrypt(E2(B))), wherein the one or more sections of encoded data (E2(B)) include one or more parameters which enable decrypted media content information (D1) to be regenerated from the one or more sections of encoded data (E2(A), E2(B), . . . ).

Optionally, decrypting executed in the decoder includes de-obfuscating data of the one or more unencrypted and/or encrypted sections of encoded data (E2(A), encrypt(E2(B)), . . . ).

Optionally, the decoder is operable to use at least one key to decrypt the encrypted media content information (D3), wherein the at least one key enables the decoder to verify an authenticity of an encoder that generated the encrypted media content information (D3).

Optionally, the decoder is operable to use the at least one key in a time-limited manner when decoding the encrypted media content information (D3).

Optionally, the decoder is operable to source at least a portion of the encrypted media content information (D3) from a proxy or relay server.

According to a fourth aspect, there is provided a codec for use with the secure media player system pursuant to the first aspect.

According to a fifth aspect, there is provided a method of communicating media content information (D1) from an encoder to at least one decoder within a secure media player system, characterized in that the method includes:
(a) processing and encoding the media content information (D1) into one or more sections of encoded data (E2(A), E2(B), . . . ), wherein at least one of the one or more sections of encoded data (E2(B)) include one or more parameters which enable the media content information (D1) to be regenerated from the one or more sections of encoded data (E2(A), E2(B), . . . );
(b) encrypting at least one of the sections of encoded data (E2(A), E2(B), . . . ) to generate corresponding one or more encrypted sections of encoded data (encrypt(E2)B))); and
(c) communicating at least one of the unencrypted and/or encrypted sections of encoded data (encrypt(E2(B))) to the at least one decoder to process the one or more unencrypted and/or encrypted sections of encoded data (E2(A), encrypt(E2(B))) to render the media content information (D3) to one or more users, whilst:
   (i) preventing storage of the one or more encrypted sections of encoded data (encrypt(E2(B))) in a decrypted form, or
   (ii) storing the one or more encrypted sections of encoded data (encrypt(E2(B))) in a decrypted form to protected memory

Optionally, in the method, at least one of the one or more sections of encoded data (E2(A), E2(B), . . . ) include customized content that is selectively included based on an identity of the at least one decoder and/or one or more characteristics of operation of the at least one decoder. Optionally, the customized content is included in a code-defining manner into the media content information (D3) when rendered at the at least one decoder, wherein the identity of the at least one decoder is discernible from the rendered media content information (D3).

Optionally, in the method, the one or more encrypted sections of encoded data (encrypt(E2(B))) are encrypted using at least one encryption key that identifies the encoder when the at least one decoder processes the one or more unencrypted and/or encrypted sections of encoded data (E2(A), encrypt(E2(B))).

Optionally, the method includes providing the at least one decoder with a complementary key to that used by the encoder when generating the one or more encrypted sections of encoded data (encrypt(E2(B))), wherein the complementary key is used by the at least one decoder to process the one or more unencrypted and/or encrypted sections of encoded data (E2(A), encrypt(E2(B))) to render the media content information (D3) to the one or more users.

More optionally, in the method, the at least one key and/or the complementary key or a reference code of the complementary key are provided from at least one of: a validating authority, a certifying authority, a verification authority, an encryption wallet.

Optionally, in the method, the at least one encryption key and/or the complementary key are time-limited. Optionally, in this regard, the method includes defining a period of time after which the one or more encrypted sections of encoded data (encrypt(E2(B))) are deemed expired, depending on whether the media content information (D1) is to be made available for online purposes or for offline purposes.

Optionally, the method includes verifying the authenticity of the at least one decoder and of the encoder to ensure reliable communication of the media content information (D1).

Optionally, the method includes customizing uniquely the one or more encrypted sections of encoded data (encrypt(E2(B))) for each corresponding decoder.

Optionally, in the method, at least the one or more unencrypted sections of encoded data (E2(A), E2(B), . . . ) are communicated via at least one relay and/or proxy server which is operable to service a plurality of decoders with the encoded data (E2(A)).

According to a sixth aspect, there is provided a computer program product comprising a non-transitory computer-readable storage medium having computer-readable instructions stored thereon, the computer-readable instructions being executable by a computerized device comprising processing hardware to execute the aforementioned method pursuant to the fifth aspect.

It will be appreciated that features of the invention are susceptible to being combined in various combinations without departing from the scope of the invention as defined by the appended claims.

### DESCRIPTION OF THE DIAGRAMS

Embodiments of the present invention will now be described, by way of example only, with reference to the following diagrams wherein:

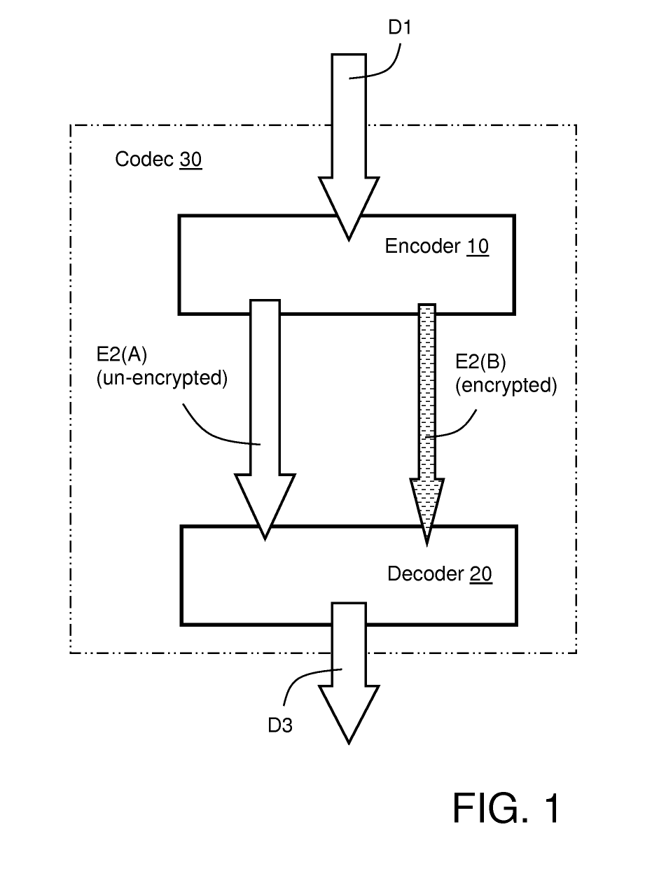

FIG. 1 is a schematic illustration of an overview of a system for distributing media content information in a more secure manner pursuant to embodiments of the present disclosure;

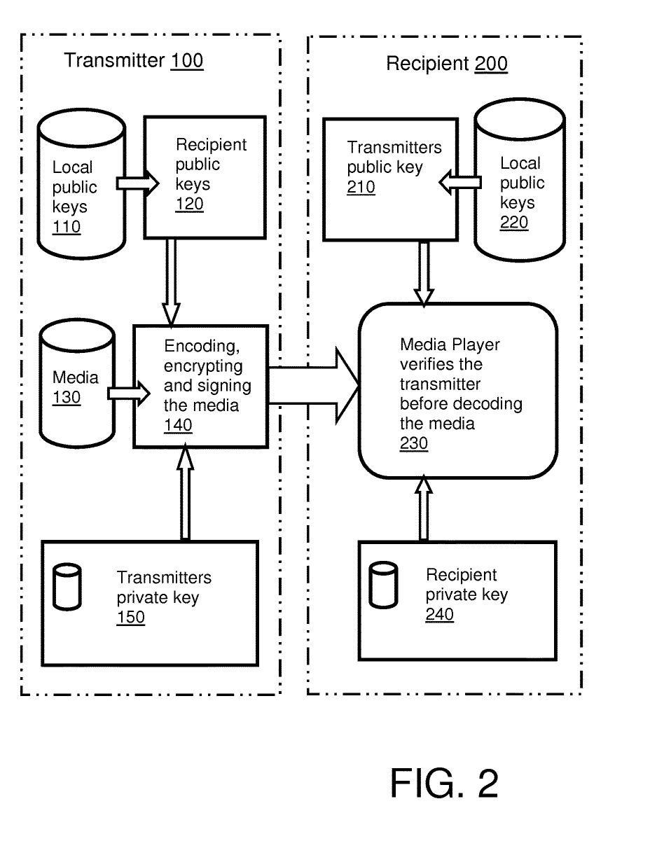

FIG. 2 is an illustration of features of a Secure Media Player pursuant to an embodiment of the present disclosure;

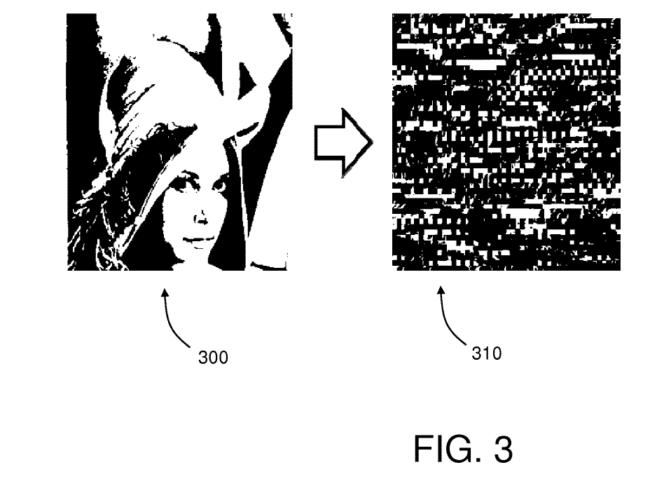

FIG. 3 is an illustration of an image, for example present in media content information (D1), and a visualization of a first section of data E2(A) conveying components present in the information D1, but without being decoded with respect to a second section of data E2(B) generated from the information (D1) during encoding in an encoder, for example included as a part of a transmitter;

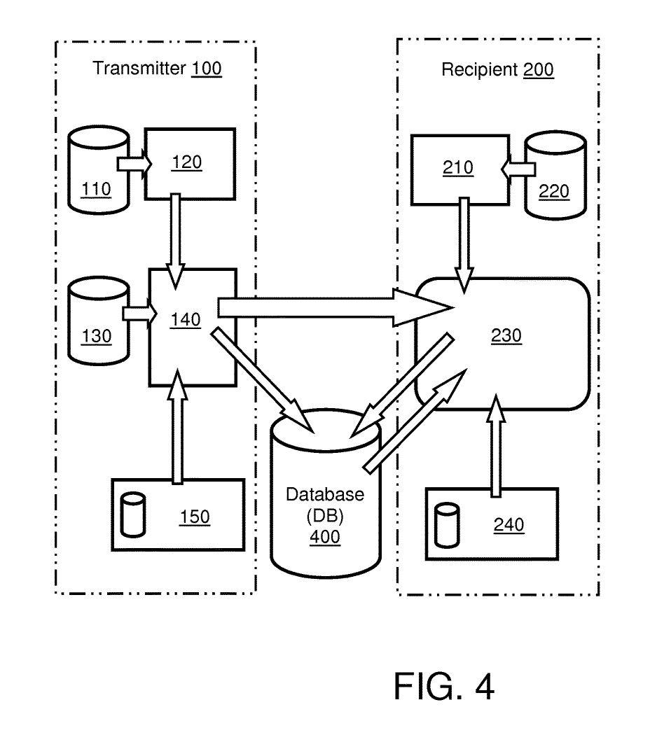

FIG. 4 is an illustration of features of the Secure Media Player of FIG. 2, employing a database (DB) arrangement;

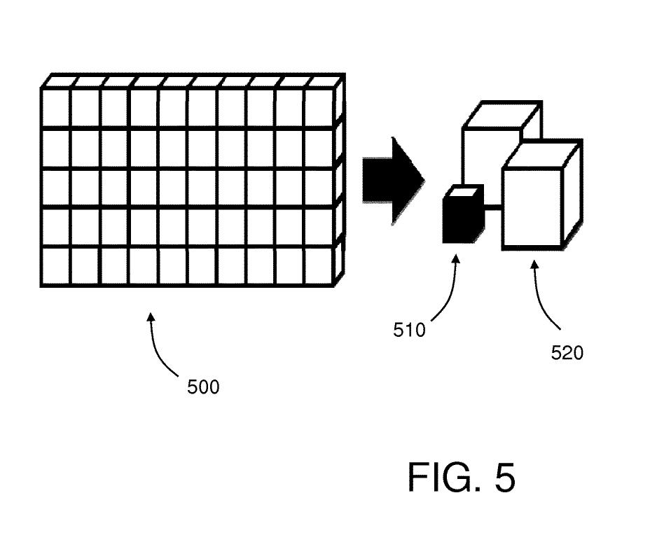

FIG. 5 is an illustration of decompressing a size of the original media content information pursuant to an embodiment of the present disclosure;

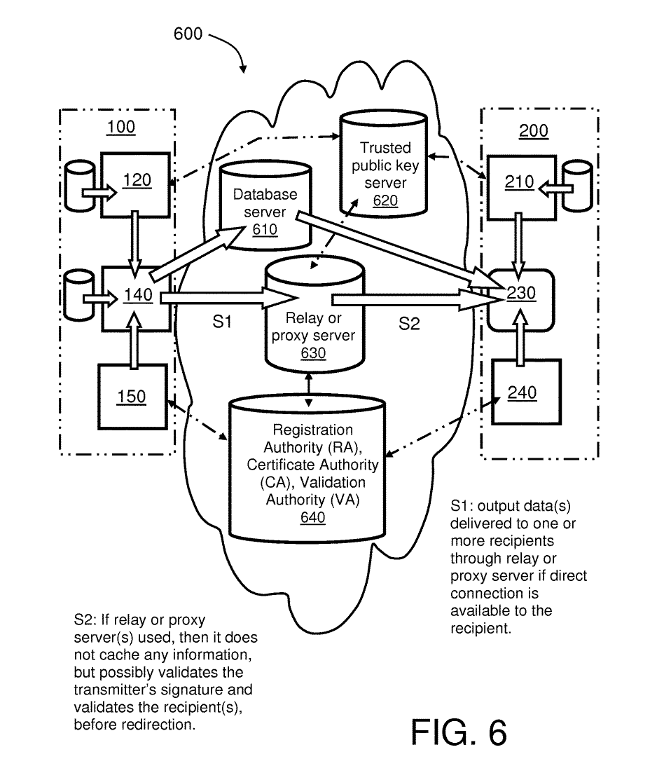

FIG. 6 is an illustration of an implementation of an embodiment of the present disclosure based on public key infrastructure; and

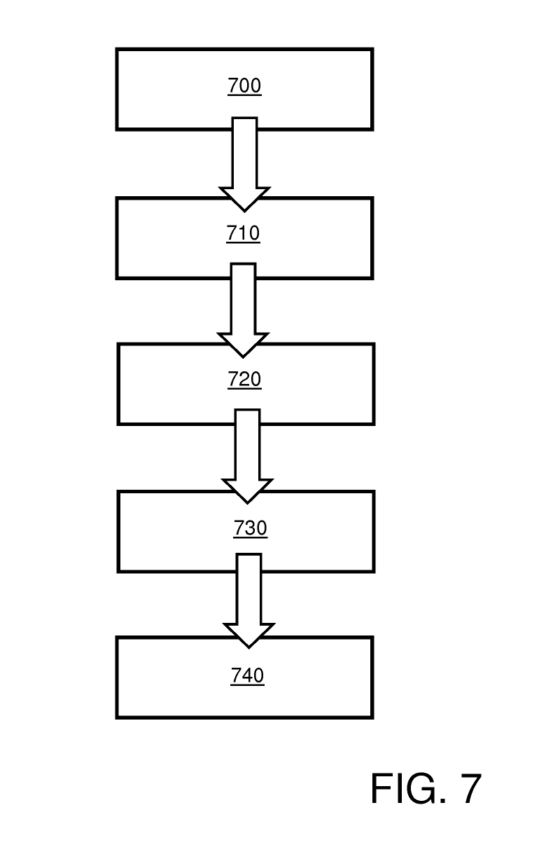

FIG. 7 is an illustration of a method of encoding and decoding data pursuant to the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments described in this disclosure are based on distributing and encrypting information and on authenticating both a given transmitter of the encrypted information (for example an “encoder”), and one or more receivers (for example one or more “decoders”) of the encrypted information via use of at least one digital signature verified by a Validation Authority (VA), thereby ensuring authentication of all parties, namely the given transmitter and the one or more receivers, and a reliable communication of the encrypted information. Moreover, the embodiments allow for portions of the information to be customized for given receivers, wherein the portions are efficiently provided from data relays and/or proxy data servers. In operation, the one or more receivers are operable to prevent storage of decrypted information in unprotected memory of the one or more receivers, thereby frustrating attempts of malware to access the information.

An example implementation of embodiments of the present disclosure is a Gurulogic® Media Player; this Media Player, namely “Secure Media Player”, makes it possible to verify the authenticity of a recipient in such a way that content can be played only by such recipients for whom it was meant. Moreover, Gurulogic® Media Player is a safe concept for media content information producers, media content information distributors and media content information owners. Technology described in this disclosure therefore implements a form of verification of authenticity and protection against unauthorized copying for renderable media content information or for other types of information. Optionally, it is possible to verify also the media content information, for example for the purposes of checking that the security classifications of the transmitter are fulfilled (for example, to verify whether or not the transmitter is allowed to send the information) or of the recipient (for example, the recipient is allowed to render the information). Such an approach enables secure media players selectively to block, namely to hinder, replaying of media content information that has been supplied from non-verified sources, thereby discouraging pirating of media data content by unscrupulous third parties. Moreover, such an approach also enables malware to be resisted by recipient computing devices, where the malware is potentially capable of extracting decoded media content information from cache memory or other secure memory of the recipient computing devices and communicating such extracted decoded media content to pirate media content distribution website, servers and similar. Embodiments of the present disclosure are operable to prevent such copying of media content data from cache memory, by ensuring that as little of the media data content is decrypted at any given moment in time.

Embodiments of the present disclosure also concern a method that keeps at least part of the media content information encrypted all the time and only the Secure Media Player is operable to open the media content information for use. Moreover, the Secure Media Player prevents storage, namely does not store or allow others to store, the media content information in an unencrypted form. Even verified users are prevented to store the media information content in an unencrypted form elsewhere than in protected memory. Generally, an Operating System (OS) or Central Processing Unit (CPU), for example a RISC processor, provides “protected (or secure) virtual memory” to software applications. This “protected memory” then either stays in Random Access Memory (RAM) or else is transferred to a paging memory on a physical hard drive or other non-volatile memory or alternatively volatile memory, if memory management configuration has thus determined, or if a user or the software application has thus decided when reserving a given block of memory in question. In an event that an attempt is made from unauthorized third-party sources to supply malware embedded in media content information to eavesdrop decrypted media content information, the Secure Media Player is able to detect an unverifiable source of the media content information and to be hindered, namely stopped, from executing such malware.

Furthermore, the Secure Media Server is able to do encryption transcoding that changes the media content information encrypted for a given server, so that the media content information is encrypted for the recipient. Optionally, national security operators can open the media content information, similarly like the Secure Media Server, and this means that, for example, authorities in the USA are able to open all content that is in their Secure Media Server, but not content that is, for example, in a China Secure Media Server, and vice versa. When multiple keys for multiple states are used then states have to co-operate, if they want to open, namely decrypt, that kind of information. Any state alone cannot decrypt the information. There is a variety of different methods to use multiple keys. The key is, for example, a combination of multiple keys, and the keys are optionally used one after another to access the same data, or different parts of the data are optionally encrypted with different keys, and so forth.

The secure transmission of media content information described for embodiments of the present disclosure provides media content information producers, media content information distributors and also end users with an opportunity to validate all parties involved in a corresponding media content information transfer chain, while simultaneously securing the media content information being transmitted in a very cost-effective way, so that security will not be compromised, thereby enabling a secure commercial implementation of various different media content information services, for example customized advertizing, customized audio for video content, customized overlay for video content, optionally 3-D video image information and so forth. Such customization is capable of enhancing user viewing experience, and/or supplying optional additional data service to users, for example in response to users paying additional service fees. Therefore, technology described in this disclosure is useable to create a safer and more secure data distribution network, for example a safer Internet.

In embodiments of the present disclosure, only the critical information of data content to be distributed is encrypted, such that, for example, 90% of the data content can be freely available for use of everybody, but this critical information, for example 10% of the data content that allows Secure Media Player to understand the data content, is encrypted for each recipient separately. Such encryption transcoding of critical information is then a relatively light data processing operation, and the Secure Media Server enables very efficient data distribution solution for, for example, online video services to be realized. Optionally, in the aforementioned example 90% of the data content that is freely available includes user-customized advertisement content, additional services, metadata for use by security authorities (for example NSA and GCHQ) to monitor a nature of the media content information to ensure that it is not of a forbidden terrorist nature, for example. Thus, embodiments of the present disclosure are capable of assisting with Internet policing, and orderly responsible use of the Internet for media content information distribution. Additionally, the metadata is useable to Internet search engines, for data mining purposes and for monitoring flows of data traffic within the Internet, or other data communication network that is utilized for implementing embodiments of the present disclosure.

Therefore, in server solutions such as aforementioned pursuant to the present disclosure, stream content to several clients simultaneously is achievable in real time, the distributed information encryption described in this disclosure is useable and thereby saves on energy spent in encryption, or uses the energy more efficiently. It will be appreciated that, in embodiments of the present disclosure, the content is beneficially encrypted for each recipient separately, but still only small fraction of the data is delivered separately for each recipient and big fraction of the data can be delivered for all recipients similarly. It is for that reason that embodiments of the present disclosure include a method for encrypting the information content itself, so that a given used transfer channel will not compromise security, even though the information were transmitted in the public Internet which enables running both an online service and an offline service simultaneously.

In principle, a majority of media content information can be transmitted in a known traditional manner by using either an unencrypted connection protocol, such as HTTP, or an encrypted one, such as HTTPS, but a most essential reason for encrypting information and to use digital signatures pursuant to embodiments of the present disclosure is to ensure the authenticity of the recipient to the transmitter, namely to detect to whom the requested information is transferred. Correspondingly, a given recipient needs to be able to know, and optionally verify, the authenticity of the transmitter. Thereby, unauthorized viewing and manipulation of media content information is prevented.

Technology described in the present disclosure is possible to implement in other ways as well, but the present disclosure provides at least one model for a public key infrastructure (PKI), adapted for the needs dictated by a usage scenario associated with the present disclosure, namely to try to guarantee secure rendering and storing of media content information; If the media content information is stored, it is also possible for the transmitter to make it expire after a period of time, after which the information can no longer be decrypted if it has expired. Such a functionality enables a control mechanism for accessing the transmitted media content information. The aforementioned Secure Media Player is also able to validate when the media content information is valid, for example by using a world clock to check time parameters of the media. That is, embodiments of the present disclosure also enable granting of user access rights to media content information for certain defined periods of time, after which the media content information is deemed expired.

In an event that a need arises later to render the media content information again, the media content information in question is beneficially requested again from the transmitter, in which case only the encrypted part of the entire media content information is transmitted, which is only a fraction of the entire media content information. However, it will be appreciated that the recipient needs to have the rest of the expired media content information still stored locally, or else it is beneficially re-downloadable from, for example, a proxy server. Therefore, the transmitter needs to keep record of whether the media content information is available for online purposes or for offline purposes, and to define an expiry date of the encrypted media content information accordingly.

Regardless of whether or not a given system for media content information pursuant to the present disclosure is running in an offline mode or an online mode, the user needs to execute one or more initialization procedures, wherein the user must have his or her own digital certificate, the creation of which the Secure Media Player will assist when necessary. Optionally, an existing certificate is used, for example to avoid an overhead of creating a new certificate for each user session.

When the user requires to obtain a digital certificate, he or she sends an application for a digital certificate to a PKI Certification Authority (CA), for example to a CA-server of Gurulogic Microsystems Oy or Verisign, that verifies the authenticity of the user at a PKI Registration Authority (RA), for example at a bank or a national Social Security Administration. Using CA and RA in combination for purposes of authentication and verification ensures that a reliable authentication mechanism is employed in embodiments of the present disclosure. In such a manner, a public key and a certificate are bound to, namely associated with, a legal personality. Optionally, the user already has a suitable certificate, in which case that suitable certificate is used, but the authenticity of the user still needs to be verified at a PKI RA. For example, if the RA is a bank, an existing authentication system for secure online banking is optionally used to verify an authenticity of a legal personality.

The PKI, CA or the Secure Media Player transmits the public key of the user to a certified key server, for example to a public key server of Gurulogic Microsystems Oy. Such an initialization procedure for PKI as described above is required of each user, regardless of whether the user is a transmitter (encoder) or a recipient (decoder).

After authenticating the user, it is possible to commence transmitting protected media content information, in such a way that either the entire media content information, or a part thereof, is encoded and encrypted, or else already partially or entirely encoded media content information is encrypted, by using a public key of the recipient and a private key of the transmitter. To save on computing resources, the media content information is optionally encrypted by using a symmetric-key cryptography method, such as AES, for which the used encryption key is produced by a pseudo-random method such as HMAC, and then the created key is encrypted by utilizing an asymmetric public key encryption method such as RSA. Partial media content information is optionally also encrypted only via utilization of a public key encryption method such as RSA. The encryption of the media content information is optionally also executed using various different combinations of encryption methods, according to usage needs. In the foregoing, it will be appreciated that “media content information” includes potentially a broad range of content, for example generated or measured content at least one of: numerical data, text data, image data, video data, seismic data, audio data, but not limited thereto.

By using procedures as described above, reliable, secure and authenticated media content information distribution is beneficially targeted per user, individually, either via utilizing online data transfer mechanisms or offline data transfer mechanisms. Normally, in known methods, the encryption of the media content information is executed on the entire content information, but embodiments of the present disclosure can also utilize, for example, a partial encryption of media content information in such way that the information is transmitted in two sections, wherein a first section contains a majority of the information and which is transmitted unencrypted, and a second section which includes a sequence which is encrypted. The two sections are optionally delivered temporally to a given user in any order; moreover, the sections are optionally in data fragments or data slices, depending upon a nature of a data transmission route employed to deliver the sections to the given user. The data fragments or data slices are susceptible to being supplied from data relays and/or proxy servers. Moreover, the data fragments or data slices are optionally customized to their recipients, for example by including targeted customized advertizing, support metadata, data overlay such translation captions for video, and so forth. The encrypted sequence contains such information which is essential for the media content information, for example including split and method selection information, headers, stream flags and so forth; without access to information in the encrypted sequence, for example an image or a video delivered to the given user would be just static, for example as illustrated in FIG. 3. Optionally, the encrypted sequence contains information on the used database such as database references and/or database delivery location and one or more selected databases, for example as illustrated in FIG. 4, without which the media content information data cannot be decompressed.

This partial encryption of media content information, pursuant to embodiments of the present disclosure, enables a very efficient way to transmit safely the essential information for decompressing the media content information. This essential information is easy to re-encrypt, even for more than one recipient, if necessary.

There is thus provided in the foregoing a novel and inventive method of transmitting media content information, such as images and video, for example as useable in an advanced form of codec. Encryption of the media content information is executed not only for a given recipient, but also for a given transmitter itself or even for a third party, if legislation of a given country in question requires that, for example pursuant to US legislation. For example, authorities of a given target country always have an opportunity the decrypt the encrypted section and to assemble the entire content using that, as do each recipient, without wasting resources, thereby saving on precious energy and preserving nature and assisting to prevent criminal activity, for example to prevent terrorist activity.

Referring to FIG. 1, there is shown an illustration of one embodiment of the present disclosure. In FIG. 1, encoder 10, for example associated with a transmitter, is operable to receive media content information represented by data D1 and to encode and/or encrypt the data D1 to generate a first un-encrypted section of data E2(A) and a second encrypted section of data E2(B); optionally, only the second section of data E2(B) is generated. The generated sections of data E2(A), E2(B) are communicated to one or more decoders 20, for example associated with one or more recipients, wherein, when available, the one or more decoders 20 are operable to decrypt the second section of data E2(B) to generate corresponding decoded data which is used to process the first section of data E2(A) at the one or more decoders 20 to generate output data D3. Encryption and decryption at the encoder 10 and the decoder 20 is optionally subject to use of various keys as will be elucidated in greater detail later. Supply of the keys is dependent upon authentication and validation of parties associated with the encoder 10 and the one or more decoders 20. Optionally, the keys are time-limited as will be described in more detail later. Optionally, the data D1 corresponds to an image indicated generally by 300 in FIG. 3, and the first section of data E2(A), if eavesdropped by an unauthorized third party, would appear as indicated generally by 310 in FIG. 3. Beneficially, the encoder 10 and the decoder 20 in combination form a codec denoted by 30.

Thus, the recipient decrypts the encrypted part, namely the second section of data E2(B), of the entire media content information and assembles the first and second sections of data E2(A) and E2(B) into an entirety, represented by the output data D3, the encoding of which is beneficially decompressed if the signature of the transmitter has been authenticated. The signature of the transmitter is beneficially verified by a Validation Authority (VA), if that has not already been done. It is also possible to verify the authenticity every time, but in practice, the verification is executed by marking a public key of the transmitter as read, in which case it is stored in a system including the encoder 10 and the one or more decoders 20, but only for a limited period, depending on the expiration date of the certificate. Despite this, the system must regularly validate the authenticity of the digital certificate at the VA in case the certificate authority has declared the certificate invalid, for example because its confidentiality was compromised.

The rendering of the media content information at the decoder 20, for example via audio replay and/or image display apparatus associated with the decoder 20, is beneficially started when the entire media content information has been at least partly decompressed into data memory associated with the decoder 20, but care is usefully taken to prevent storage, namely not to store, the decompressed part into such a RAM/ROM memory which can later be loaded in an unencrypted manner. Such an example player of media content information also optionally reinitialize all its used memories after the data D3 has been consumed to avoid residual data being in some data memory after consumption thereof, for example by way of user viewing the media content information; such reinitialization is optionally partial, for example only a subset of the RAM memory locations are overwritten or reset, thereby reducing processing effort and memory data bus access utilization. According to an embodiment of the present disclosure, the encryption integrated into the encoder 10, as described in not yet public patent application GB 1414007.3 filed by the Applicant, is beneficially used, in which case the system decompresses encrypted information only a fraction at a time, which prevents someone from attempting to capture the decompressed information from the player. However, such an approach does not prevent a third party merely making a video recording and/or audio recording of the media content information rendered to a given user, albeit often of somewhat inferior quality; this is achieved by making a video, for example, of a display screen of a rendering device.

Procedures described above prevent entire copying of media content information, at least in its original quality, because as a counterpart to the encryption integrated into the encoder 10 described above, the decryption of encrypted content is integrated into the decoder 20, which prevents copying of information. Therefore, Gurulogic Microsystems has developed technologies, for example as described in a granted patent U.S. Pat. No. 8,675,731 B2 (“Encoder and method”, ref. GURU004US), patent application EP 13002520.8 (“Decoder and method”, ref. GURU005EP), patent application GB 1416631.8 (“Encoder, Decoder and Methods employing partial encryption”), and GB 1414007.3, (“Encoder, Decoder and Methods”) which are susceptible to being implemented precisely as described above. It is also possible to use other technologies and other codecs, as long as the Secure Media Player and optionally Secure Media Server solutions are used.

As aforementioned, nothing prevents a user to copy directly the media content from the display by using a video camera, but in that case it will no longer be authentic media, namely lossless. By customizing the media content information to each user, for example via customizing one or more fragments of data that are displayed at a given user recipient device, an identity of the user recipient device is discernible in the direct copy of the media content; for example, by customizing a choice of advertisements for each user as a form of code, the user responsible for the direct copy can be discerned from analysis of the direct copy. By such an approach, the user responsible for the direct copy can be investigated and, potentially, prosecuted by copyright infringement investigators.

Moreover, techniques exist with which the video being rendered can be captured simply by installing a virtual video card into a computer, but a risk of getting caught limits the number of perpetrators, because each authenticated user has been verified according to the jurisprudence of the target country. Optionally, watermarking is added to the media content information when decoded to generate the decrypted data D3, wherein the watermarking is implemented to be unique for each recipient. The watermarking is implemented, for example by imposing a constant faint watermarking image over region of static image information present in the media content information represented by the data D1.

This means that the perpetrators will have to think twice before starting to commit a copyright infringement. Moreover, in the system described above, as each party has been authenticated, it is made possible to distribute in the media content information, such example audio-visual information that is targeted precisely for an individual user, for the one that it was originally sent to. Therefore, if the user had copied the content with a video camera and then given that copyright-protected material into public distribution, it would be possible to find out who the perpetrator was and to hold that person legally accountable for his or her actions. Such targeting includes, for example, a combination of a plurality of user-unique advertisements which are added discreetly to images of the media content information, as aforementioned, for example in a code defining manner. For example, for a given recipient R1, a combination of advertisements A1, A3, A5 and A6 as well as a film F are included in media content provided to the recipient R1, whereas for a given recipient R2, a combination of advertisements A2, A4, A5, and A7 as well as the film F are included in the media content provided to the recipient R2, and so forth. Optionally, the advertisements A2 to A7 are relatively similar, but include detectable subtle mutual differences. Thus, the recipient R1 is identifiable by a code “A1, A3, A5, A6”, and the recipient R2 is identifiable by a code “A2, A4, A5, A7”. Optionally, longer forms of code can be employed, wherein the advertisements are included in a different order and in different playing time locations within the media content, when rendered. The recipients R1, R2 merely experience the film F with a few unnoticeable interspersed advertisements therein, before and/or after.

Each Secure Media Player beneficially also attempts to prevent video window screen captures by using video overlay in the window, in which case the operating system cannot capture or analyze the video image rendered on the screen. Moreover, the Secure Media Player can be set to be allowed to operate only in a limited set of accepted device configurations, depending on the signature of the media content information.

As illustrated in FIG. 2, the media content information, represented by the data D1 in FIG. 1, is beneficially encoded in its entirety, but in some embodiments only an essential fraction of it is encrypted, namely the section of data E2(B). It will also be appreciated that the data D1 optionally only contains one section of data (E2(B)), and it can be encrypted entirely or partially. For encoding the media content information, for example a proprietary GMVC® codec is used, which yields a cost-effective compression ratio and simultaneously encapsulates various different pieces of information of the media content information, from among which essential sequences of information can then be selected that will be encrypted using, for example, a public key infrastructure.

In FIG. 2, there is shown an illustration of component parts associated with a transmitter 100 and a recipient 200 of an embodiment of the present disclosure. The transmitter 100 includes the encoder 10, and the recipient includes the decoder 20. There is optionally a plurality of recipients 200 connected to a transmitter 100, forming a system pursuant to the present disclosure.

The transmitter 100 includes access to a database 110 of local public keys 110 for providing recipient public keys 120. Moreover, the transmitter 100 includes access to media content information from a media database 130. Furthermore, the transmitter 100 includes access to the transmitter's private keys, denoted by 150. The transmitter 100 also includes an encoding arrangement 140, for example including the encoder 10, for encoding, encrypting and signing media content information provided to the encoding arrangement 140 from the media database 130.

The recipient 200 includes access to a local public key database 220 for providing the transmitter's public key 210. Moreover, the recipient 200 includes access to a database 240 for providing the recipient's private key. Furthermore, the recipient 200 includes a decoding arrangement 230, for example including the decoder 20, which is operable to verify the transmitter 100 before commencing to decode the data E2(A) and E2(B) received thereat for generating corresponding output data D3, as described in the foregoing.

A manner in which the system pursuant to the present disclosure functions is described in overview, but at its simplest, the transmitter 100 must encrypt desired pieces of information by using his or her private key, against the public keys of the recipients 200. Thereby, a majority of the media content information, namely the data D1, is beneficially transferred in an unencrypted manner, which enables a very fast and reliable technique for transferring encrypted media content information to be achieved in operation in the system, whereby the transmitter 100 makes sure who will receive the data E2(A) and E2(B), and correspondingly, the recipient 200 is ensured that the transmitter's origins are authentic. It will be appreciated that the unencrypted information to be transmitted, namely the data E2(A), is optionally sent together with the encrypted content, namely the data E2(B), or they can be sent separately, namely the data E2(A) is sent via a different route to that employed to send the data E2(B). The two sections are optionally delivered temporally to a given user in any order; moreover, the sections are optionally in data fragments or data slices, depending upon a nature of a data transmission route employed to deliver the sections to the given user.

In FIG. 3, there is shown an illustration of a depiction of how a decoded image looks like when an attempt has been made to decompress the image without the tiny little fraction E2(B) of the encoded media content information which simply defines where the blocks are situated and what their sizes are, for example. This kind of result can be seen with human eyes. If more information were to be encrypted, then it would be very probable that a media decompressor would not be able to finish the image, because the code would contain too many syntax errors. Designing this example alone requires a lot of sophisticated knowledge on how a video decoding process operates, for example as employed in the aforementioned GMVC® codec. However, this example demonstrates that the majority of encoded media content information can be transmitted unencrypted, via the section of data E2(A), and over an unencrypted transfer channel, but without the tiny little piece of encrypted vital information, namely the section of data E2(B), the rest of the media content is unusable.

In an embodiment illustrated in FIG. 4, the media content information D1 is encoded in its entirety, but only those pieces of information are encrypted, namely in the section of data E2(B), which have been selected to be downloaded from a central database (DB) 400. In this case, any information referring to the database 400 needs to be encrypted and to be transmitted in encrypted format, among the rest of the encoded information or separately. Thereby, the database references define all the rest of the information that is necessary for decompressing and rendering the encoded media content E2(A) and E2(B). It will be appreciated that the database depicted in FIG. 4 (DB) can simultaneously function as an authenticity controller, namely as a validation authority (VA), for the transmitter 100, for the recipient 200 and also for the information itself.

If a piece of information referred to in the reference cannot be found in the database (DB) 400, then this missing piece needs to be transmitted to the database 400 or to a centralized database. The database 400 can be local, namely mirrored from the centralized databases, but it can also be an external database that operates independently or that is connected with other databases, thereby constructing its own database system. The recipient 200 fetches the missing pieces of information for the centralized database, which makes it possible to render and possibly store the media content information as explained above. More details on the usage of databases for employing the embodiment pursuant to the disclosure can be found in the database solution designed and patented by Gurulogic Microsystems Oy in GB 2509055 A.

In FIG. 5, there is an illustration of a size of the original media content information, namely the data D1 indicated generally by 500, that is encoded into a much compressed size, indicated generally by 520, and simultaneously the selected fraction of vital information, indicated by 510, is encrypted, wherein this fraction is considerably smaller than the entire encoded media content information, namely a combination of 510 and 520. This way, the media content information can be both transmitted securely and cost-effectively and its authenticity can be verified. It will be appreciated that encryption algorithms require a lot of processing time and consume a lot of electricity and computing power. Therefore, the overall capacity of the system is saved to be used for other functionalities, especially in mobile devices that operate on battery power, and also in server farms, where the critical factor is energy consumption and not their computing capacity. It will also be appreciated that the information components present in the data 520 can relate to data blocks of mutually different sizes and that increases even more the security of the information content protection provided by the system of the disclosure.

Referring next to FIG. 6, there is shown an illustration of a public key infrastructure which is adapted for secure transmitting and rendering of media content information as described in the foregoing. It will be appreciated that the validation authority (VA) is optionally situated in the database server, namely the database 610, if a database server is used. Moreover, FIG. 6 depicts the use of a relay server and a proxy server 630, as a possible transmitter or as filter, depending on whether the transmitter 100 or the recipient 200 needs to comply with an information security policy that is used when communicating in a network in question.

Optionally, anti-virus software, a firewall or other data security related matter may require the use of relay servers or proxy servers as mentioned above; optionally, these relay servers or proxy servers are selected on a connectional basis or geographical basis to one or more recipients receiving media content, pursuant to embodiments of the present disclosure. In principle, the secure transmitting of media content information described for embodiments of the present disclosure does not require that an encrypted connection be used between the transmitter 100 and the recipient 200, even though it is advisable and yields additional protection and possibly prevents the attackers from abusing the vulnerabilities of information systems. It is beneficial to use a newest TLS-encrypted connection between the transmitter 100 and the recipient 200, and also between all the other parties involved, but especially when communicating with Registration Authorities (RA), Certificate Authorities (CA) and Validation Authorities (VA).

In an embodiment described above, public key infrastructure is optionally used, which is known for several different vulnerabilities unless an encrypted connection is used when communicating with the various authorities. It will be appreciated that the operation of a public key server must be protected in such a way that it is allowed to store only verified keys thereat, in which case malicious or undesired parties are prevented from posing as another recipient 200.

It will be appreciated that the public key of a user will be transferred automatically to a public key server only in connection with the certification procedure. When the user adds verified public keys to his or her information system, it must be made sure that they are stored securely, correspondingly as the user's private key is stored as protected by the user's password for the computer in question. As regards data security, it is important to understand which is the weakest link of entirety of the encryption system, namely when and where the certificates of the terminal devices are stored and how strong encryption keys are used for encrypting the media content information D1. The encryption of the information D1 itself does not cause a security issue if mutually agreed security measures are obeyed, but it is usually the user himself or herself that causes the severest problems regarding data security. With the Secure Media Player solution pursuant to the disclosure, there is optionally additional security added also in situations where the private key is somehow been received by a third party. If the Secure Media Player solution has been implemented by employing a proprietary codec such as GMVC® and the control of the Secure Media Player(s) is made properly, there should not be any Secure Media Player provided by others available that can show the encrypted content, even if the third party knows the private key. Even if it were possible to open the encrypted content E2(A) and E2(B), there would still not suitable player available that could show the entire media content information D1.

Embodiments of the present disclosure are beneficially employed in combination with novel codec technologies described in a granted patent U.S. Pat. No. 8,675,731 B2 (“Encoder and method”, ref. GURU004US), patent application EP 13002520.8 (“Decoder and method”, ref. GURU005EP), patent application GB 1416631.8 (“Encoder, Decoder and Methods employing partial encryption”) and GB 1414007.3, (“Encoder, Decoder and Methods”) that makes it possible to provide both stronger encryption keys than previously, and also a more secure way to transfer information between the transmitter 100 and the recipient 200. Novel codec technologies includes encryption of information in connection with encoding the information, which makes it possible to encrypt the information with a stronger encryption key than in prior art solutions, and also encrypting only a small part of the information. When this new method of encrypting information is integrated, for example, with the encoding of image or video information in such a way that only a fraction of the entire information sequence is encrypted, without which the decompression of the information is possible, regardless of used prediction methods, considerable gains are achieved as compared with known data communication arrangement, for example used for distributing media content information such as movies. Known data communication arrangements require that the entire telecommunications connection be encrypted, or entire content to be communicated.

Optionally, encryption employed in embodiments of the invention include dividing up data, for example media content, to be encrypted into data blocks, obfuscating the data blocks by swapping data between the data blocks, while making a record of such swaps in a data map, and then encrypting the obfuscated data blocks, together with the data map to provide corresponding encrypted data. When implemented in such a manner, such encryption is susceptible to approaching a “one-time-pad”, namely providing unbreakable encryption based on present sophisticated computing devices, for example large contemporary supercomputers. Alternatively, the data blocks are first encrypted, and thereafter obfuscated. Obfuscation can be achieved quickly in computing hardware using an XOR instruction, for example a native processor instruction of a RISC processor or similar. When decoding, the data map is decrypted, to provide a decrypted data map, and then the decrypted data map is used to perform decryption and de-obfuscation to regenerate data at the decoder, for example decrypted media content.

For example, using the encryption method presented in this invention, before a movie is transmitted to a consumer, only certain important references and/or the database delivery information are encrypted, which are optionally downloaded from another server and which are vital for assembling and decompressing an entire video content of the movie. These references are only a fraction of the entire movie content, but without these selected parts of reference information, the rest of the video content becomes unusable, for example as illustrated in FIG. 3. To ensure a functional system, it is important not to select such pieces of information as references which would be easy to predict mathematically, such as the DC-components used in coding video images, which would be fairly easy to detect and thus would not guarantee secure operation.

Referring next to FIG. 7, steps 700 to 740 depict principal steps of methods employed in embodiments of the present disclosure.

In the encoder 10, in the step 700, the media content information D1 is received and the encoder 10 processes the media information content information D1 into one or more sections of encoded data (E2(A), E2(B), . . . ), wherein at least one of the one or more sections of encoded data (E2(B)) includes one or more parameters which enable the media content information D1 to be regenerated from the one or more sections of encoded data (E2(A), E2(B), . . . ). Generation of the sections of data (E2(A), E2(B), . . . ) require one or more encoding processes to be implemented in computing hardware of the encoder 10.

The parameters include, but are not limited to, at least one of:
(i) information indicative of selection of an encoding method employed;
(ii) information indicative of splitting of data blocks when encoding data and/or encrypting data;
(iii) information indicative of one or more entropy coding methods applied when encoding data, for example use of optional obfuscation as described in the foregoing, for example swapping bits between data blocks and/or selectively inverting bits;
(iv) a length of the data streams employed when operating the media player system;
(v) information indicative of reordering of the data; and
(vi) other header information such as data formats, minimum and maximum block sizes.

It will be appreciated that the one or more sections of data further include validating information such as an ordinal number of an encryption key that is used, or the used encryption key, and optionally time information regarding the usability of the data, advertisements, personal content and such, but this information is not parameters that are needed to utilize the first section of data. Moreover, it will be appreciated that, in case there is too little data to be encrypted, either entirely or in the data section to be encrypted, then the section of data in question is optionally padded with random values before encryption. In such a case, the decoder needs to know the locations the padding was added into in any given received data section at the decoder, so as to be able to omit the extra values when decrypting the received data section. The padded data is useful for misleading malware that is often unable to distinguish between real media content and padded data. Moreover, the padded data optionally has a similar statistical bit value distribution to the real media content, so that even malware with data analysis functionality will be frustrated by embodiments of the present disclosure by being unable to distinguish desired media content from the padded content.

In the encoder 10, in the step 710, at least one of the sections of encoded data (E2(B)) is encrypted, for example using a private key of the encoder 10 and/or a public key of the recipient 20. Optionally, these keys are time limited, as aforementioned, for example to control when given media content is available to recipients, for example as a function of subscription payments being made.

In the step 720, at least one of the unencrypted and/or encrypted sections of encoded data (encrypt(E2(B))) are communicated from the encoder 10 to the at least one decoder 20, for example directly or via one or more proxy or relay servers of a data communication network, for example in a manner as illustrated in FIG. 6. Such use of proxy or relay servers enables data communication load via, for example, the Internet to be spread, to avoid occurrence of communication latency and delays.

In the step 730, the decoder 20 receives the encoded data (E2(A), E2(B), . . . ) and then optionally checks that the encoded data (E2(A), E2(B), . . . ) has been encoded by an authorized and validated transmitter 100. In an event that the encoded data (E2(A), E2(B), . . . ) is acceptable, the decoder 20 proceeds to decrypt the encoded data (encrypt E2(B)) to generate one or more parameters required for decoding the encoded data (E2(A), E2(B), . . . ) to regenerate a version of the data D1. Optionally, transcoding is employed in the decoder 20 when the data D1 has to be reformatted in relation to rendering facilities available in association with the decoder 20, for example screen size, screen aspect ratio, screen resolution, screen rotation and such like.

In the step 740, the decoder 20 renders the regenerated data D1, transcoded when required, to a user of the recipient 200 incorporating the decoder 20.

In the following, an embodiment of the invention will be introduced, where the data is processed to a first section of data E2(A) and a second section of data E2(B):

In the encoder 10, in the step 700, the media content information D1 is received and the encoder 10 processes the media content information to generate a first section of data E2(A), and a second section of data E2(B) (in unencrypted format), wherein the second section of data E2(B) provides one or more parameters which enable the media content information D1 to be regenerated from the first section of data E2(A). Generation of the sections of data E2(A), E2(B) require one or more encoding processes to be implemented in computing hardware of the encoder 10.

The parameters include, but are not limited to, at least one of:
(i) information indicative of selection of an encoding method employed;
(ii) information indicative of splitting of data blocks when encoding data and/or encrypting data;
(iii) information indicative of one or more entropy coding methods applied when encoding data;
(iv) a length of the data streams employed when operating the media player system;
(v) information indicative of reordering of the data; and
(vi) other header information such as data formats, minimum and maximum block sizes.

It will be appreciated that the one or more [second] sections of data further include validating information such as an ordinal number of an encryption key that is used, or the used encryption key, and optionally time information regarding the usability of the data, advertisements, personal content and such, but this information is not parameters that are needed to utilize the first section of data. Moreover, it will be appreciated that, in case there is too little data to be encrypted, either entirely or in the data section to be encrypted, then the section of data in question is optionally padded with random values before encryption. In such a case, the decoder needs to know the locations the padding was added into in any given received data section at the decoder, so as to be able to omit the extra values when decrypting the received data section.

In the encoder 10, in the step 710, the second section of data E2(B) is encrypted, for example using a private key of the encoder 10 and/or a public key of the recipient 20. Optionally, these keys are time limited.

In the step 720, the first section of data E2(A), and the second section of data E2(B) in encrypted form, are communicated from the encoder 10 to the decoder 20, for example directly or via one or more proxy or relay servers of a data communication network, for example in a manner as illustrated in FIG. 6.

In the step 730, the decoder 20 receives the encoded data E2(A), E2(B) and then optionally checks that the encoded data E2(A), E2(B) has been encoded by an authorized and validated transmitter 100. In an event that the encoded data E2(A), E2(B) is acceptable, the decoder 20 proceeds to decrypt the encoded data E2(B) to generate one or more parameters required for decoding the encoded data E2(A) to regenerate a version of the data D1. Optionally, transcoding is employed in the decoder 20 when the data D1 has to be reformatted in relation to rendering facilities available in association with the decoder 20, for example screen size, screen aspect ratio, screen resolution, screen rotation and such like.

In the step 740, the decoder 20 renders the regenerated data D1, transcoded when required, to a user of the recipient 200 incorporating the decoder 20.

Optionally, the encoder 10 and the decoder 20 are spatially collocated within one device, for example a smart phone, a video camera, a personal computer, a medical apparatus, a seismic apparatus, a satellite, a drone, a surveillance system, a video conferencing system and the encoded data E2(A), E2(B) is stored within the device and/or spatially externally thereto.

Techniques employed in embodiments of the present disclosure, as described in the foregoing, are optionally employed for crisis handling and medical purposes, in cases where very secure and reliable encryption is desired, but an unprotected telecommunications connection needs to be used between one or more recipients; for example, in crisis situations such as natural disasters, terrorist atrocities and similar, it is often desirable to communicate promptly considerable quantities of sensitive data in an at least partially encrypted form via use of data communication links of limited bandwidth and using computing resources of modest computing power. The embodiments of the present disclosure provide a way to use known, but well tried-and-tested, technology in a novel manner, which makes it possible for a given media content producer to decide who is allowed to see and/or hear the media content, thus offering a safer option to distribute and render media content both online and offline, regardless of a given transfer channel that is used.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A secure media player system for communicating media content information (D1) from an encoder (10, 100) to at least one decoder (20, 200), wherein the encoder (10, 100) is configured:
(a) to process and encode the media content information (D1) into one or more sections of encoded data (E2(A), E2(B), . . . ), wherein at least one of the one or more sections of encoded data (E2(B)) include one or more parameters which enable the media content information (D1) to be regenerated from the one or more sections of encoded data (E2(A), E2(B), . . . );
(b) to encrypt at least one of the one or more sections of encoded data (E2(B) . . . ) to generate corresponding one or more encrypted sections of encoded data (encrypt(E2(B))); and
(c) to communicate at least one of the one or more unencrypted and/or encrypted sections of encoded data (encrypt(E2(B))) to the at least one decoder (20, 200) to process the one or more unencrypted and/or encrypted sections of encoded data (E2(A), encrypt(E2(B)), . . . ) to render the media content information (D3) to one or more users, wherein the secure media player system:
(i) prevents storage of the one or more encrypted sections of encoded data (encrypt(E2(B))) in a decrypted form, or
(ii) stores the one or more encrypted sections of encoded data (encrypt(E2(B))) in a decrypted form to protected memory.

2. A secure media player system of claim 1, wherein the at least one of the one or more sections of encoded data (E2(A), E2(B), . . . ) include customized content that is selectively included based on an identity of the at least one decoder (20, 200) and/or one or more characteristics of operation of the at least one decoder (20, 200), wherein the customized content is included in a code-defining manner into the media content information (D3) when rendered at the at least one decoder (20, 200), wherein the identity of the at least one decoder (20, 200) is discernible from the rendered media content information (D3).

3. A secure media player system of claim 1, wherein the one or more encrypted sections of encoded data (encrypt(E2(B))) are encrypted using at least one encryption key that identifies the encoder (10, 100) when the at least one decoder (20, 200) processes the one or more unencrypted and/or encrypted sections of encoded data (E2(A), encrypt(E2(B))).

4. A secure media player system of claim 1, wherein the at least one decoder (20, 200) is provided with a complementary key to that used by the encoder (10, 100) when generating the one or more encrypted sections of encoded data (encrypt(E2(B))), wherein the complementary key is used by the at least one decoder (20, 200) to process the one or more unencrypted and/or encrypted sections of encoded data (E2(A), encrypt(E2(B))) to render the media content information (D3) to the one or more users.

5. A secure media player system of claim 3, wherein the at least one encryption key and/or the complementary key or a reference code for the complementary key are provided from at least one of: a validating authority, a certifying authority, a verification authority, an Encryption Wallet.

6. A secure media player system of claim 3, wherein the at least one encryption key and/or the complementary key are time-limited.

7. A secure media player system of claim 6, wherein the encoder (10, 100) is operable to define a period of time after which the one or more encrypted sections of encoded data (encrypt(E2(B))) are deemed expired, depending on whether the media content information (D1) is to be made available for online purposes or for offline purposes.

8. A secure media player system of claim 1, wherein the encoder (10, 100) is operable to verify the authenticity of the at least one decoder (20, 200), and the at least one decoder (20, 200) is operable to verify the authenticity of the encoder (10, 100), thereby ensuring reliable communication of the media content information (D1).

9. A secure media player system of claim 1, wherein the system is operable to customize uniquely the one or more encrypted sections of encoded data (encrypt(E2(B))) for each corresponding decoder (20, 200).

10. A secure media player system of claim 1, wherein at least the one or more unencrypted sections of encoded data (E2(A), E2(B), . . . ) are communicated via at least one relay and/or proxy server which is operable to service a plurality of decoders (20, 200) with the encoded data (E2(A)).

11. An encoder (10, 100) for use with a secure media player system as claimed in claim 1.

12. A decoder (20, 200) for use with a secure media player system of claim 1.

13. A decoder (20, 200) of claim 12, wherein the decoder (20), 200) is configured to receive at least partially encrypted media content information (D3) and to process therefrom one or more unencrypted and/or encrypted sections of encoded data (encrypt(E2(B)), . . . ) to render the media content information (D3) to one or more users, wherein the decoder (20, 200);
(i) is prevented from storing the one or more encrypted sections of encoded data
(encrypt(E2(B))) in a decrypted form, or
(ii) stores the one or more encrypted sections of encoded data (encrypt(E2(B))) in a decrypted form to protected memory of the decoder (20, 200).

14. A decoder (20, 200) of claim 12, wherein the decoder (20, 200) is operable to decrypt at least one of one or more sections of encoded data (E2(B) . . . ) to generate corresponding one or more decrypted sections of data (encrypt(E2(B))), wherein the one or more sections of encoded data (E2(B)) include one or more parameters which enable decrypted media content information (D1) to be regenerated from the one or more sections of encoded data (E2(A), E2(B), . . . ).

15. A decoder (20, 200) of claim 13, wherein the decrypting executed in the decoder (20, 200) includes de-obfuscating data of the one or more unencrypted and/or encrypted sections of encoded data (E2(A), encrypt(E2(B)), . . . ).

16. A decoder (20, 200) of claim 13, wherein the decoder (20, 200) is configured to use at least one key to decrypt the encrypted media content information (D3), wherein the at least one key enables the decoder (20, 200) to verify an authenticity of an encoder that generated the encrypted media content information (D3).

17. A decoder (20, 200) of claim 16, wherein the decoder (20, 200) is configured to use the at least one key in a time-limited manner when decoding the encrypted media content information (D3).

18. A decoder (20, 200) of claim 13, wherein the decoder (20, 200) is operable to source at least a portion of the encrypted media content information (D3) from a proxy or relay server.

19. A codec (10, 20; 100, 200) for use with a secure media player system as claimed in claim 1.

20. A method of communicating media content information (D1) from an encoder (10, 100) to at least one decoder (20, 200) within a secure media player system, wherein the method comprises:
(a) processing and encoding the media content information (D1) into one or more sections of encoded data (E2(A), E2(B,) . . . ), wherein at least one of the one or more sections of encoded data (E2(B)) include one or more parameters which enable the media content information (D1) to be regenerated from the one or more sections of encoded data (E2(A), E2(B), . . . );
(b) encrypting at least one of the one or more sections of encoded data (E2(A), E2(B), . . . ) to generate corresponding one or more encrypted sections of encoded data (encrypt(E2(B))); and
(c) communicating at least one of the unencrypted and/or encrypted sections of encoded data (encrypt(E2(B))) to the at least one decoder (20, 200) to process the one or more unencrypted and/or encrypted sections of encoded data (E2(A), encrypt(E2(B))) to render the media content information (D3) to one or more users, whilst:
(i) preventing storage of the one or more encrypted sections of encoded data (encrypt(E2(B))) in a decrypted form,
(ii) storing the one or more encrypted sections of encoded data (encrypt(E2)B))) in a decrypted form to protected memory.

21. A method of claim 20, wherein at least one of the one or more sections of encoded data (E2(A), E2(B), . . . ) include customized content that is selectively included based on an identity of the at least one decoder (20, 200) and/or one or more characteristics of operation of the at least one decoder (20, 200), wherein the customized content is included in a code-defining manner into the media content information (D3) when rendered at the at least one decoder (20, 200), wherein the identity of the at least one decoder (20, 200) is discernible from the rendered media content information (D3).

22. A method of claim 20, wherein the one or more encrypted sections of encoded data (encrypt(E2(B))) are encrypted using at least one encryption key that identifies the encoder (10, 100) when the at least one decoder (20, 200) processes the one or more unencrypted and/or encrypted sections of encoded data (E2(A), encrypt(E2(B))).

23. A method of claim 20, wherein the method includes providing the at least one decoder (20, 200) with a complementary key to that used by the encoder (10, 100) when generating the one or more encrypted sections of encoded data (encrypt(E2(B))), wherein the complementary key is used by the at least one decoder (20, 200) to process the one or more unencrypted and/or encrypted sections of encoded data (E2(A), encrypt(E2(B))) to render the media content information (D3) to the one or more users.

24. A method of claim 22, wherein the at least one encryption key and/or the complementary key or a reference code for the complementary key are provided from at least one of: a validating authority, a certifying authority, a verification authority, an Encryption Wallet.

25. A method of claim 22, wherein the at least one encryption key and/or the complementary key are time-limited.

26. A method of claim 25, wherein the method includes defining a period of time after which the one or more encrypted sections of encoded data (encrypt(E2(B))) are deemed expired, depending on whether the media content information (D1) is to be made available for online purposes or for offline purposes.

27. A method of claim 20, wherein the method includes verifying the authenticity of the at least one decoder (20, 200) and of the encoder (10, 100) to ensure reliable communication of the media content information (D1).

28. A method claim 20, wherein the method includes customizing uniquely the one or more encrypted sections of encoded data (encrypt(E2(B))) for each corresponding decoder (20, 200).

29. A method of claim 20, wherein at least the one or more unencrypted sections of encoded data (E2(A), E2(B), are communicated via at least one relay and/or proxy server which is operable to service a plurality of decoders (20, 200) with the encoded data (E2(A)).

30. A computer program product comprising a non-transitory computer-readable storage medium having computer-readable instructions stored thereon, the computer-readable instructions being executable by a computerized device comprising processing hardware to execute a method as claimed in claim 20.
